(19) United States
(12) Patent Application Publication
(10) Pub. No.: US 2008/0005949 A1
(43) Pub. Date: Jan. 10, 2008

(54) Sell tab sheet

(76) Inventor: Timothy J. Flynn, Key Largo, FL (US)

Correspondence Address: Mark D. Swanson;Pauley Petersen & Erickson, Suite 365, 2800 West Higgins Road, Hoffman Estates, IL, 60169, US

(21) Appl. No.: 11/820,736

(22) Filed: Jun. 20, 2007

Related U.S. Application Data
(60) Provisional application No. 60/815,054, filed on Jun. 20, 2006.

(51) Int. Cl. G09F 3/00

(52) U.S. Cl. 40/674

(57) ABSTRACT

A printable sheet including a sheet matrix and a plurality of removable tabs cut within the sheet matrix and aligned in a column adjacent an edge of the printable sheet. Each of the removable tabs is separated from the sheet matrix by a first line of separation and is separated from an adjacent removable tab by a second line of separation. The removable tabs can be printed with information, such as a contact phone number, that a person reading the sheet, such as including an advertisment, may want to remove for later reference. A tearable and removable strip can be disposed between the column of removable tabs and the edge of the printable sheet to support the tabs during printing.

### CROSS REFERENCE TO RELATED APPLICATION

This application claims the benefit of U.S. Provisional Patent Application, Ser. No. 60/815,054, filed on 20 Jun. 2006. The co-pending Provisional Patent Application is hereby incorporated by reference herein in its entirety and is made a part hereof, including but not limited to those portions which specifically appear hereinafter.

### BACKGROUND OF THE INVENTION

This invention relates to a perforated sheet that includes a print area for displaying information and also tabs that a reader can remove or take away, such as to retain a portion of the displayed information.

### SUMMARY OF THE INVENTION

A general object of the invention is to provide a printable sheet including removable tabs for use as, for example, advertisement postings where detachable tabs with contact telephone numbers are attached to the sheet.

The general object of the invention can be attained, at least in part, through a printable sheet including a plurality of removable tabs disposed along an edge of the printable sheet, where each of the removable tabs is defined at least in part by a tearable line of separation.

The invention further comprehends a printable sheet. The printable sheet includes a sheet matrix and a plurality of removable tabs cut within the sheet matrix and aligned in a column adjacent an edge of the printable sheet. Each of the removable tabs is separated from the sheet matrix by a first line of separation and is separated from an adjacent removable tab by a second line of separation.

The invention still further comprehends a printable sheet that includes a sheet matrix and a plurality of tabs cut within the sheet matrix. Each of the plurality of tabs is defined by tearable lines of separation and the tabs are aligned in a tab column. A portion of the sheet matrix is disposed adjacent a first longitudinal side of the tab column and a tearable strip is adjacent a second longitudinal side of the tab column that is opposite the first longitudinal side. The tearable, and thus removable, strip is disposed between the column of removable tabs and the edge of the printable sheet.

### BRIEF DESCRIPTION OF THE DRAWINGS

This invention can better be understood with reference to the following drawings.

FIG. 1 is a plan view of one embodiment of a tab or label sheet, including three areas: a main printing surface, removable tabs and a tearable strip of material.

FIG. 2 is a plan view of another embodiment of a tab or label sheet, according to this invention.

FIG. 3 is a plan view of another embodiment of a tab or label sheet, according to this invention.

FIG. 4 is a plan view of another embodiment of a tab or label sheet, according to this invention.

FIG. 5 is a plan view of another embodiment of a tab or label sheet, according to this invention.

In the drawings, like reference numerals designate corresponding parts throughout the different views. The drawings are not necessarily to scale, and emphasis instead is placed upon clearly illustrating principles of this invention.

### DESCRIPTION OF THE DRAWINGS

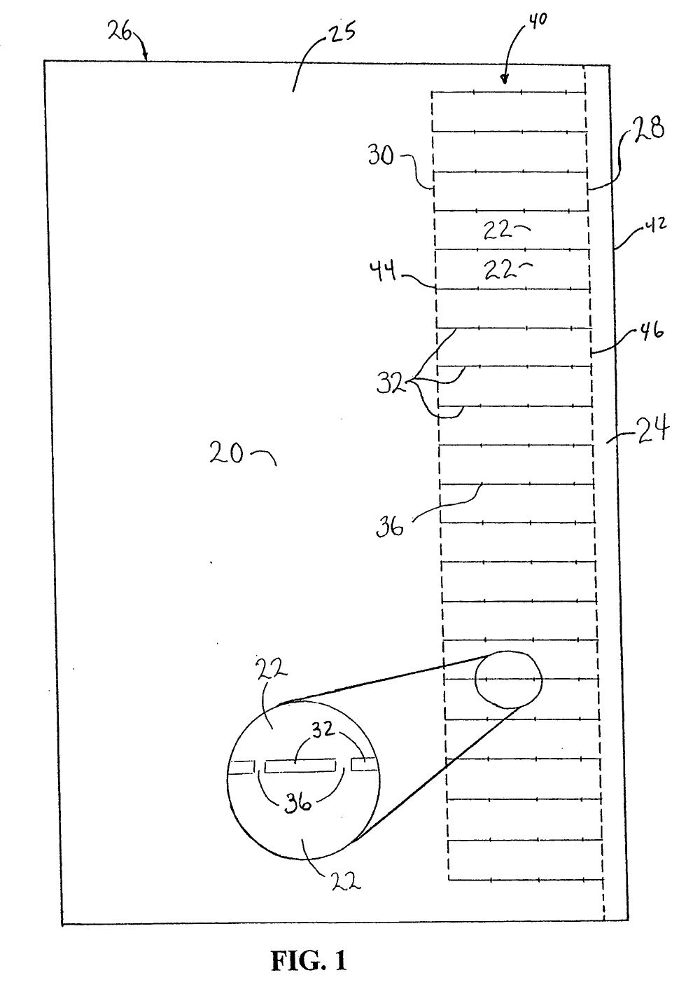

FIG. 1 illustrates a tab or label sheet according to one embodiment of this invention. Sheet 26 can be made or constructed from any suitable sheet or other printable material, such as discussed in U.S. Pat. No. 6,427,905, or any other flat sheet or acetate type material. Sheet 26 can be of any suitable shape and/or any suitable size. The sheet 26 is desirably of any suitable shape, and generally any suitable size that can be accepted by and fed through a printer, such as a laser printer or an ink jet printer. Common sizes of paper generally fed through printers are 8.5 inches by 5.5 inches, 8.5 inches by 11 inches, 8.263 inches by 11.688 inches (A4 size), and 8.5 inches by 14 inches. The sheet material 26 is preferably, but not necessarily, constructed of any suitable paper, paper composite, non-metal and/or metal material. Other suitable materials for constructing the material sheet 26 include fabric, plastic, and metal foils.

Sheet 26 comprises main print area 20, one or more tabs 22, and one or more tearable strips 24. Main print area 20 includes a printable surface and is shown in FIG. 1 as a blank area to the left of both the tabs 22 and the removable tearable strip 24. The sheet 26 and the printable surface of the print area 20 can be any paper or a variety of face materials, such as are known for making pressure sensitive, or self-adhesive labels. Such face materials may include, but are not limited to: smudge-proof stock, litho stock, cast coated stock, tag stock, fluorescent stock, foils, computer printable polyester, vinyl, satin cloth, Tyvek™ material, flexible plastic, book papers, photo quality papers and/or photo quality film. Furthermore, various portions of the face materials can be different colors, thereby resulting in different colored parts, or preprinted with any of various designs.

The phrase “printable surface” relates to a surface of any type of matter upon which a person or machine can draw, print, color, paint, photocopy, write, emboss, or make any other type of mark or graphic. Laser printers, ink jet printers, impact printers, thermal transfer printers, direct thermal printers, typewriters, or any other suitable graphic printing devices are preferred but not necessary for use with printable surfaces according to this invention.

The printable sheet 26 includes a plurality of removable tabs 22 disposed along an edge 42 of the printable sheet 26. Each of the removable tabs 22 is defined by tearable lines of separation (lines 28, 30, and 32 in FIG. 1). The tabs 22 are cut within a sheet matrix 25 and aligned in a column 40 adjacent, but not necessarily abutting or forming, the edge 42 of the sheet 26. Each of the removable tabs 22 is separated from the sheet matrix by at least a first line of separation 30 and is separated from an adjacent removable tab 22 by a second line of separation 32. A portion of the sheet matrix 25 is disposed adjacent a first longitudinal side 44 of the tab column 40. The top and bottom tabs 22 of the column 40 are also separated from the optional surrounding matrix 25 by a line of separation 32.

A tear-away or tearable strip 24 is disposed adjacent a second longitudinal side 46 of the tab column 40 that is opposite the first longitudinal side 44. The tearable strip 24 is disposed between the column 40 of removable tabs 22 and the edge 42 of the printable sheet 26. A further tearable line of separation 28 is between the tearable strip 24 and the removable tabs 22. Tearable strip 24 is optional and generally desired for allowing for improved performance, such as when running the sheet assembly of this invention through a printer or other similar printing or graphic application device. Tearable strip 24 can provide structure and support to sheet material 26, such as when passing through a printer and/or can protect tabs 22 from fraying or tattering, such as when the sheet assembly of this invention is routed through the printer. Tearable strip 24 is separated or removed from tabs 22 and main print area 20 by applying a force that generally pulls along and/or away from line of separation 28.

Lines of separation 28, 30 and 32 can be formed by micro-perforations, perforations, die-cuts, or kiss-cuts, or any other method for creating a line of weakness or a line of separation in sheet 26 can be used, alone or in any combination. In FIG. 1, tabs 22 are positioned or disposed between line of separation 28 and backing line of separation 30. Backing line of separation 30 provides a line of weakness or a line of separation between tabs 22 and main print area 20. Backing line of separation 30 is preferably created or formed by perforations. However, micro-perforations, a die-cut, a kiss-cut, or any other method for creating a line of weakness or a line of separation in sheet 26 can be used.

Tabs 22 are each defined on longitudinal sides by two parallel lines of separation 32, which may or may not be generally perpendicular to line of separation 28 and/or backing line of separation 30. In certain embodiments of this invention, lines of separation 32 can be created or formed by a die-cut, perforations, micro-perforations, a kiss-cut, and/or any other method or structure for creating a line of weakness in sheet material 26. When lines of separation 32 are formed by a die-cut, for example, lines of separation 32 can include one or more tab connectors 36 extending between each of the removable tabs and an adjacent removable tab and/or the sheet matrix 25 (for the first and last tab in the column 40). The tab connectors 36 desirably provide support, or a bridging structure, to and/or between tabs 22. Connectors 36 can prevent tabs 22 and/or sheet 26 from buckling, for example as sheet 26 is fed through a printer or another printing device. Connectors 36 within or between die-cut lines of separation 32 can provide a relatively clean edge when tabs 22 are separated from sheet 26 of this invention.

As will be appreciated by those skilled in the art following the teachings herein provided, various and alternative sizes, shapes, and configurations are available for the sheet, tabs, print area, tearable strip, lines of separations, and connectors of this invention, including, but not limited to or by, the further embodiments discussed below.

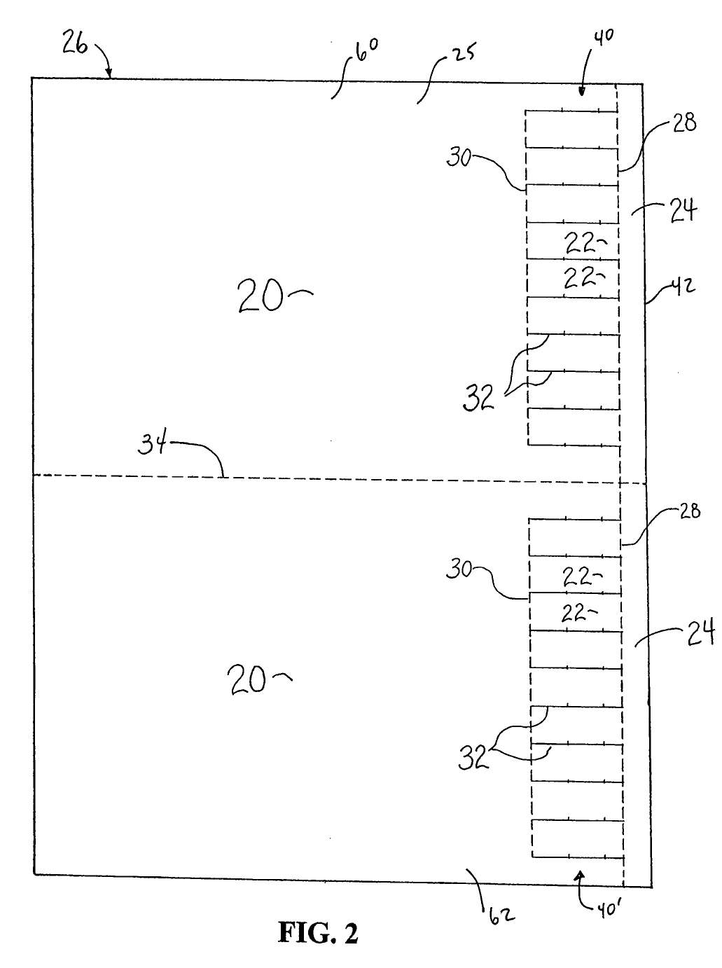

FIG. 2 shows another embodiment of a sheet or label assembly according to this invention. FIG. 2 shows elements similar to the elements shown in FIG. 1, but with a sheet divider 34 for creating or providing two sets of the tab or sheet portions on one sheet 26. Sheet divider 34 is formed by perforations. However, micro-perforations, a die-cut, a kiss-cut, or any other method or structure for creating or forming a line of weakness in sheet material 26 can be used. A first plurality of tabs 22 is disposed in a first column 40 on a first sheet portion 60 and a second plurality of removable tabs 22 is arranged in a second column 40′ on a second sheet portion 62. In the embodiment of FIG. 2 the first sheet divider line of separation 34 extends across the printable sheet 26 and between the first and second columns 40 and 40′ of removable tabs 22. In FIG. 2, the first and second columns 40 and 40′ of the plurality of removable tabs 22 are both disposed along the edge 42 of the printable sheet 26.

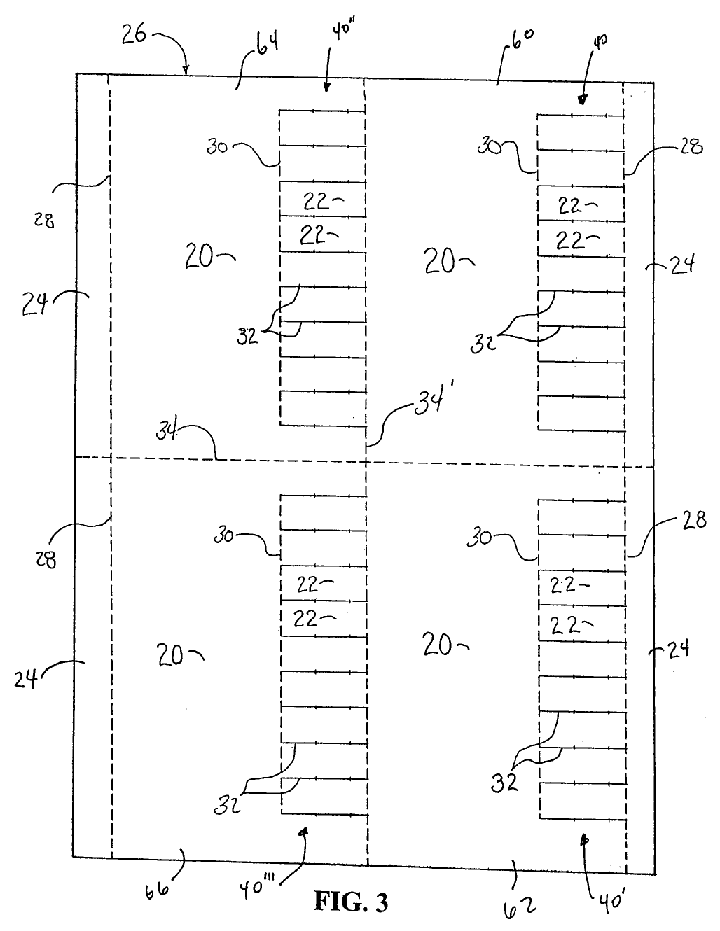

FIG. 3 shows another embodiment of a sheet or label assembly according to this invention. FIG. 3 shows elements similar to the elements shown in FIG. 1, but with two sheet divider lines of separation 34 and 34′ for creating or providing four sheet portions and four sets of tab or label sheets on one sheet material 26. Sheet divider 34 is generally perpendicular to line of separation 28 and sheet divider 34′ is generally parallel to line of separation 28. A third plurality of removable tabs 22 is disposed in a third sheet portion 64 and arranged in a third column 40″ along the second sheet divider line 34′. A fourth plurality of removable tabs 22 is disposed in a fourth sheet portion 66 and arranged in a fourth column 40″′ along the second sheet divider line 34′. Each of the first through fourth pluralities of removable tabs 22 are defined at least by a tearable line of separation 28, 30, and 32, such as discussed above. FIG. 3 also shows an optional second line of separation 28 on the opposite side of the sheet material 26 and adjacent the third and fourth sheet portions 64 and 66. The second line of separation 28 can provide a second removable tearable strip 24 for enhanced print quality and possible total print coverage of main print area 20.

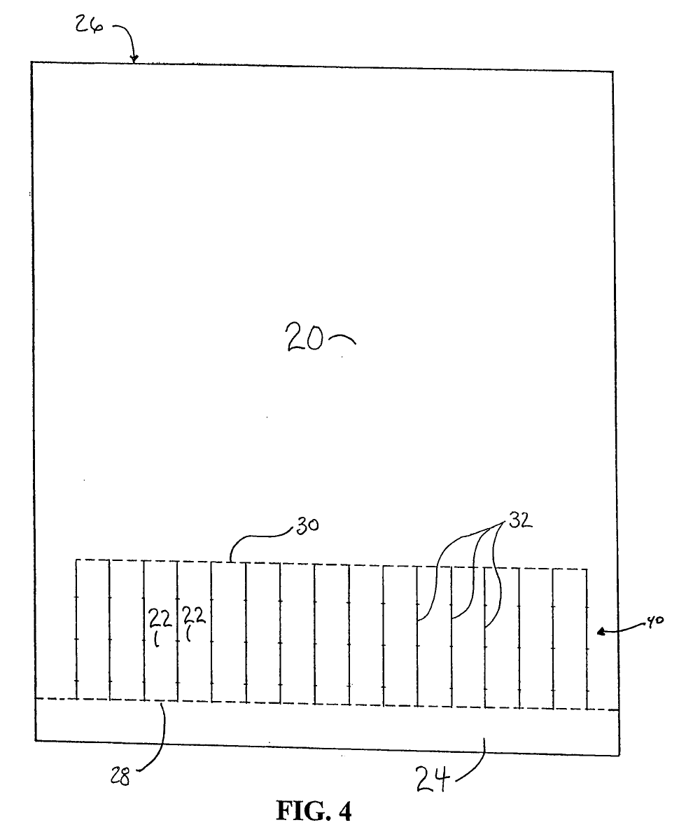

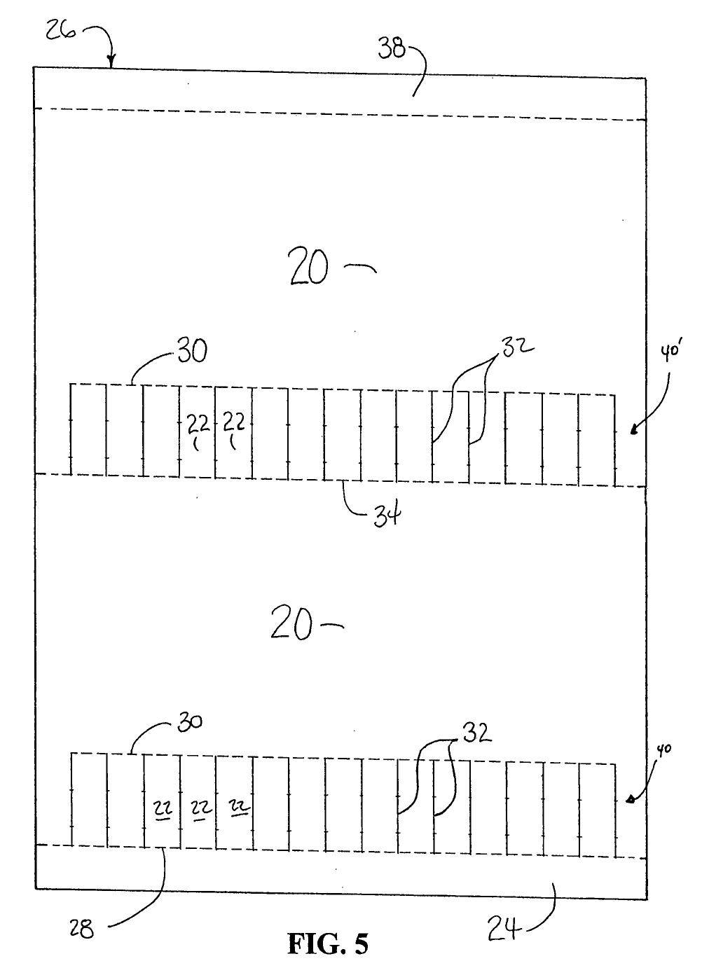

FIGS. 4 and 5 each illustrate a further alternative embodiment of this invention. Similar to that discussed above, sheet 26 includes a column 40 of tabs 22 defined by a line of separation 28, backing line of separation 30 and one or more parallel line of separation 32. In the embodiments of FIG. 4 the column 40 of tabs, are disposed along a width of sheet 26. In other words, the column 40 is disposed along the shorter edge of the sheet 26, or a horizontal edge of sheet 26 instead of a vertical edge of sheet 26.

FIG. 5 shows a sheet divider line of separation 34 forming two columns 40 and 40′ of tabs 22 with this horizontal assembly or arrangement. The second column 40′ of the second plurality of removable tabs 22 is disposed along and abutting (and formed in part by) the sheet divider line of separation 34.

FIG. 5 shows one embodiment of a leading edge 38 that can optionally be incorporated into various embodiments of the sheet assembly of this invention. Leading edge 38 can provide a removable strip for enhanced print quality and possible total print coverage of main print area 20. Leading edge 38 can be fed first into a printer or another similar device. A roller or another suitable feed device or structure can engage leading edge 38 and thus pull sheet material 26 through the printer or other similar device. Leading edge 38 can protect, for example, main print area 20 and tabs 22 from binding, tattering and/or tearing. Leading edge 38 can desirably generally improve the print quality of the sheet assembly of this invention. Leading edge 38 can be created or formed by micro-perforations. However, perforations, a die-cut, a kiss-cut or any other method for creating a line of weakness or a line of separation in sheet material 26 can be used, alone or in any combination.

One process for using the sheet assembly of this invention includes first, running the sheet assembly of this invention through a printer or another similar device. If sheet 26 has one or more sheet divider lines of separation 34, before or after the printing step, the sheet 26 of this invention can be folded and/or separated along each sheet divider line of separation 34. The sheet can be folded and/or separated along line of separation 28 to remove the strip(s) 24 from the sheet assembly 26 of this invention, leaving the tabs 22 and any connectors 36 intact. The remaining main print area 20 and the tabs 22 can be hung, such as to advertise something available for rent or sale, and display tabs 22 are easily removable along line of separations 30 and 32 by interested observers.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A printable sheet, comprising:
a plurality of removable tabs disposed along an edge of the printable sheet; and
each of the removable tabs defined at least in part by a tearable line of separation.

2. The printable sheet of claim 1, wherein the plurality of removable tabs are alinged in a column along the printable sheet edge.

3. The printable sheet of claim 2, further comprising:
a tearable strip disposed between the column of removeable tabs and the edge of the printable sheet; and
a tearable line of separation between the tearable strip and the removable tabs.

4. The printable sheet of claim 1, further comprising at least one tab connector extending between each of the removeable tabs and an adjacent removable tab.

5. The printable sheet of claim 1, further comprising a plurality of tab connectors extending between each of the removable tabs and an adjacent removable tab.

6. The printable sheet of claim 2, further comprising:
a second plurality of removable tabs arranged in a second column, each of the second plurality of removable tabs defined at least in part by a tearable line of separation; and
a first sheet divider line of separation extending across the printable sheet and between the first and second columns of removable tabs.

7. The printable sheet of claim 6, wherein the second column of the second plurality of removable tabs is disposed along the edge of the printable sheet.

8. The printable sheet of claim 6, wherein the second column of the second plurality of removable tabs is disposed along the first sheet divider line of separation.

9. The printable sheet of claim 6, further comprising:
a second sheet divider line of separation extending across the printable sheet perpendicular to and extending across the first sheet divider line of separation, the first and second sheet divider lines of separation dividing the printable sheet into four sheet portions, the first plurality of removable tabs disposed in a first sheet portion and the second plurality of removable tabs disposed in a second sheet portion;
a third plurality of removable tabs disposed in a third sheet portion and arranged in a third column along the second sheet divider line, each of the third plurality of removable tabs defined at least in part by a tearable line of separation; and
a fourth plurality of removable tabs disposed in a fourth sheet portion and arranged in a fourth column along the second sheet divider line, each of the fourth plurality of removable tabs defined at least in part by a tearable line of separation.

10. The printable sheet of claim 9, further comprising:
a first tearable strip disposed between the first and second sheet portions and the edge of the printable sheet;
a tearable line of separation between the first tearable strip and the first and second sheet portions;
a second tearable strip disposed between the third and fourth sheet portions and a second edge of the printable sheet opposite the printable sheet edge; and
a tearable line of separation between the second tearable strip and the third and fourth sheet portions.

11. A printable sheet, comprising:
a sheet matrix;
a plurality of removable tabs cut within the sheet matrix and aligned in a column adjacent an edge of the printable sheet, wherein each of the removable tabs is separated from the sheet matrix by a first line of separation and is separated from an adjacent removable tab by a second line of separation.

12. The printable sheet of claim 11, wherein the second line of separation comprises a die cut.

13. The printable sheet of claim 11, further comprising a plurality of tab connectors extending between each of the removable tabs and an adjacent removable tab.

14. The printable sheet of claim 11, wherein the sheet matrix surrounds the column of removable tabs.

15. The printable sheet of claim 14, further comprising:
a tearable strip disposed between the column of removable tabs and the edge of the printable sheet; and
a tearable line of separation between the tearable strip and a remainder of the printable sheet.

16. The printable sheet of claim 11, further comprising:
a second plurality of removable tabs cut within the sheet matrix and aligned in a second column, wherein each of the removable tabs is separated from the sheet matrix by a first line of separation and is separated from an adjacent removable tab by a second line of separation; and
a first sheet divider line of separation extending across the printable sheet and between the first and second columns of removable tabs.

17. The printable sheet of claim 16, wherein the second column of the second plurality of removable tabs is disposed along the edge of the printable sheet.

18. A printable sheet, comprising:
a sheet matrix;
a plurality of tabs cut within the sheet matrix, each of the plurality of tabs defined by tearable lines of separation, the tabs including a tab column;
a portion of the sheet matrix disposed adjacent a first longitudinal side of the tab column;
a tearable strip adjacent a second longitudinal side of the tab column that is opposite the first longitudinal side, the tearable strip disposed between the column of removable tabs and the edge of the printable sheet.

19. The printable sheet of claim 18, wherein the tearable line of separation along each of the first and second longitudinal sides of the tab column comprises perforations.

20. The printable sheet of claim 18, further comprising:
a second plurality of tabs cut within the sheet matrix, each of the plurality of tabs defined by tearable lines of separation, the tabs including a tab column; and
a first sheet divider line of separation extending across the printable sheet and between the first and second columns of tabs.
